(19) United States
(12) Patent Application Publication
(10) Pub. No.: US 2010/0283210 A1
(43) Pub. Date: Nov. 11, 2010

(54) SEALS

(75) Inventors: Christian Kirchner, Dortmund (DE); Mark Ansley-Watson, Middlesex (GB)

Correspondence Address: DAVIS & BUJOLD, P.L.L.C., 112 PLEASANT STREET, CONCORD, NH, 03301, US

(73) Assignee: JOHN CRANE UK LIMITED, Slough (GB)

(21) Appl. No.: 12/812,081

(22) PCT Filed: Dec. 23, 2008
(86) PCT No.: PCT/GB08/04273

§ 371 Date: Jul. 16, 2010

(30) Foreign Application Priority Data
Jan. 11, 2008 (GB) 0800509.2

(51) Int. Cl. F16J 15/34

(52) U.S. Cl. 277/377

(57) ABSTRACT

A seal (10, 12) having a mating ring (100, 100′) mounted in a fixed axial and rotational relationship with respect to a shaft (14) and a primary ring (120, 120′) mounted in fixed rotational relationship but movable axially with respect to a housing assembly (16). Springs (136) are provided to urge the primary ring (120, 120′) axially into sealing engagement with the mating ring (100, 100′). The mating ring (100, 100′) are mounted with respect to the shaft (14) in abutment with a first radial face (44, 62). A circumferential surface of the mating ring (100, 100′) is spaced radially from a circumferential surface on the shaft (14) and an annular helical spring element (104) is located, under radial compression, between the circumferential surfaces. The annular helical spring element (104) is formed from wire of elongate section, the axial width of the section being greater than the radial thickness.

This application is a national stage completion of PCT/GB2008/004273 filed Dec. 23, 2008 which claims priority from British Application Serial No. 0800509.2 filed Jan. 11, 2008.

### FIELD OF THE INVENTION

The present invention relates to seals in particular mechanical face seals in which a seal face on a primary sealing ring is biased axially into sealing engagement with a seal face on a mating ring.

### BACKGROUND OF THE INVENTION

Typically in such seals, the mating ring is mounted for rotation with a shaft, for example as illustrated in U.S. Pat. No. 5,700,013, in which the mating ring is mounted on a sleeve which is adapted to be non-rotatably mounted on a shaft. The mating ring abuts a radial face of a flange formation on the sleeve and is sealed with respect thereto by means of a spring energised polymer seal located in an annular recess in the radial face of the flange formation, so that it abuts a rear radial face of the mating ring. The internal cylindrical surface of the mating ring abuts the external surface of the sleeve, thereby centering the mating ring with respect to the shaft. One or more drive pins extend axially from the flange formation and engaging corresponding bores in the rear face of the mating ring, to prevent rotation of the mating ring relative to the sleeve.

The arrangement disclosed above takes no account of thermal expansion of the sleeve and/or mating ring and engagement of the internal cylindrical surface of the mating ring with the sleeve, may lead to abutment fretting.

Alternatively, the mating ring may be mounted in fixed axial and rotational relationship to a housing, to surround an aperture through which a shaft may pass.

### SUMMARY OF THE INVENTION

According to one aspect of the present invention, a seal comprises a mating ring mounted in fixed axial and rotational relationship with respect to one component of a pair of relatively rotatable components; and a primary ring mounted in fixed rotational relationship but moveable axially with respect to the other component; means being provided to urge the primary ring axially into sealing engagement with the mating ring, the mating ring being mounted with respect to said one component in abutment with a first radial face on said one component, characterised in that a circumferential surface of said mating ring is spaced radially from a circumferential surface on said one component and an annular helical spring element is located, under radial compression, between said circumferential surfaces, the annular helical spring element being formed from wire of elongate section, the axial width of the section being greater than the radial thickness.

In accordance with the present invention, the annular helical spring element will act to centralise the mating ring with respect to the circumferential surface of the associated component, while the space between the mating ring and the component will permit differential thermal expansion, the annular helical spring element being compressed or expanded radially to accommodate the relative thermal expansion or contraction of the mating ring and component. Moreover, the annular spring element will transmit drive between the mating ring and associated component, thus avoiding the need for drive pins or other means, for this purpose.

According to a further aspect of this invention, the annular helical spring element may also act between radial surfaces on the mating ring and the associated component, to urge the mating ring axially into sealing engagement with a radial face of the associated component.

According to a further aspect of the invention a centering element for centering one component of a pair of coaxial components with respect to the other component comprises an annular helical spring element, characterised in that said annular helical spring element is formed from wire of elongate section, the axial width of the section being greater than the radial thickness.

The dimensions of the section of the wire used to form the annular helical spring element, will depend on the radial spring rate required. However, preferably the annular helical spring element would be formed from wire of rectangular section with an axial width to radial thickness ratio of from 5:1 to 10:1

The diameter of the helical spring element will depend on the spacing between the opposed cylindrical surfaces of the mating ring and component, which will be designed with respect to the relative thermal coefficients of the materials used and the temperature range over which the seal is designed to operate.

The radial resilience of the spring element will also depend on the ratio of the pitch of the convolutions and the axial thickness of the wire. For a given wire section, the lower this ratio, that is the more upright the convolutions, the higher the radial resilience of the spring element. The pitch to width ratio will consequently be selected to give an appropriate radial spring rate, depending on the section of the wire used, but typically the pitch to width ratio will be less than 2:1 and more preferably about 1.6:1, so that there will be axial overlap at diametrically opposed positions of each convolution and some of the compressive load will be transmitted radially from the side of the spring element in engagement with the mating ring to the side of the spring element in engagement with the associated component.

### BRIEF DESCRIPTION OF THE DRAWINGS

The invention is now described, by way of example only, with reference to the accompanying drawings, in which:—

FIG. 1 illustrates in cross section, a seal in accordance with the present invention;

FIG. 2 is an enlarged view of a portion of the seal illustrated in FIG. 1; and

FIG. 3 is an enlarged perspective view of a spring element used in the seal illustrated in FIG. 1.

### DETAILED DESCRIPTION OF THE INVENTION

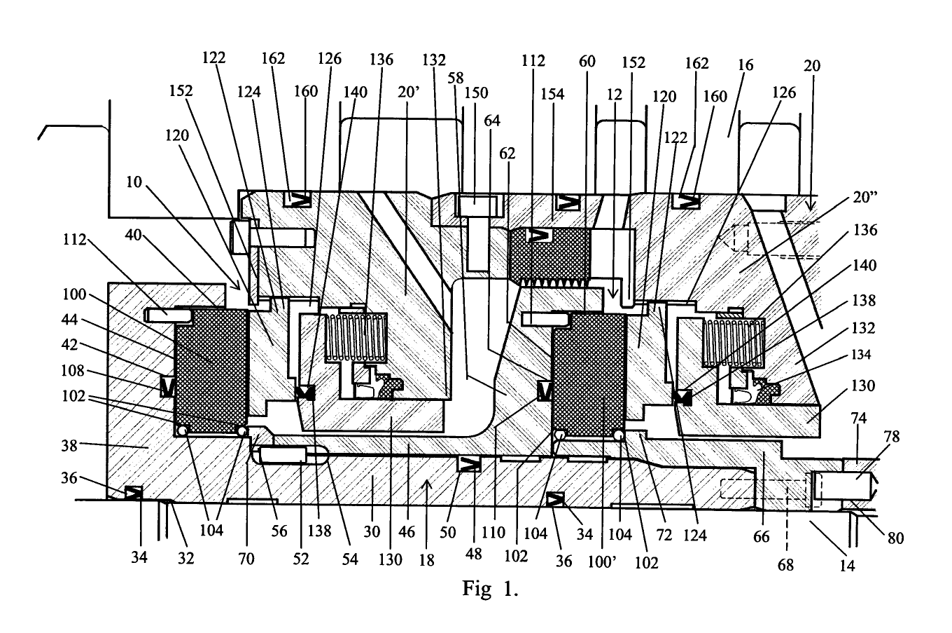

As shown in FIG. 1 a seal assembly comprises inboard and outboard seals 10, 12 located at axially spaced positions, between a shaft 14 and a machine housing 16. The seal assembly is of cartridge configuration, having an inner sleeve assembly 18 adapted to be secured non-rotatably and sealed with respect to the shaft 14 and an outer housing assembly 20, adapted to be located non-rotatably in a bore in the machine housing 16, through which the shaft 14 passes.

The inner sleeve assembly 18 comprises an inner sleeve member 30 which is a push fit on the shaft 14, the inner sleeve member 30 having a stepped bore 32 which corresponds to a stepped external surface of the shaft 14 to limit axial movement of the inner sleeve member 30 on the shaft 14. Polymer seals 34 are located in circumferential grooves 36 in the bore of the inner sleeve member 30, for engagement of the surface of the shaft 14 to provide a seal between the inner sleeve member 30 and the shaft 14. The inner sleeve member 30 defines a flange formation 38 at its inboard end. An annular, axially extending recess 40 is provided in the radial face of the outboard side of the flange formation 38 and an annular groove 42 is provided in the radial base 44 of the recess 40.

A radially outer sleeve member 46 is a push fit on the external surface of the inner sleeve member 30 and is sealed with respect thereto by means of a polymer seal 48 located in a circumferential groove 50 in the external circumferential surface if the inner sleeve member 30. A key member 52 locates in axially extending grooves 54, 56 in the external circumferential surface of the inner sleeve member 30 and the internal circumferential surface of the radially outer sleeve member 46 respectively, to prevent rotation of the radially outer sleeve member 46 relative to the inner sleeve member 30.

A flange formation 58 is provided at the out board end of the radially outer sleeve member 46, the bore 60 of the outer sleeve member 46 being of increased diameter in the flange formation 58 to define a radial shoulder 62. An annular groove 64 is provided in the radial shoulder 62.

An axially outer sleeve member 66 has a stepped bore, the outboard end of the bore being a push fit on the shaft 14 while the inboard larger diameter end of the bore is a push fit on the inner sleeve member 30. The outboard end of axially outer sleeve member 66 is secured to the outboard end of inner sleeve member 30 by means of a plurality of angularly spaced axially extending bolts 68. When the axially outer sleeve member 66 is bolted to the inner sleeve member 30, the inboard end of the axially outer sleeve member 66 abuts the radial shoulder 62 and clamps the radially outer sleeve member 46 against the flange formation 38 of the inner sleeve member 30, with a ring 70 disposed between the inboard end of the radially outer sleeve member 46 and flange formation 38. The external circumference of ring 70 extends radially outwardly of the inner circumferential wall of the recess 40.

A flange formation 72 extends outwardly from the outer circumferential surface of the axially outer sleeve member 66.

The inner sleeve assembly 18 is secured axially on a stepped portion of the shaft 14, by means of a clamping collar 74. The collar 74 abutting the outboard end of the axially outer sleeve member 66 and being clamped to the shaft 14 by a plurality of angularly spaced radial set screws (not shown). A series of angularly spaced drive pins 78 engage in axial bores 80 in the end of the axially outer sleeve member 66 and the collar 74 to prevent rotation of the inner sleeve assembly 18 relative to the shaft 14.

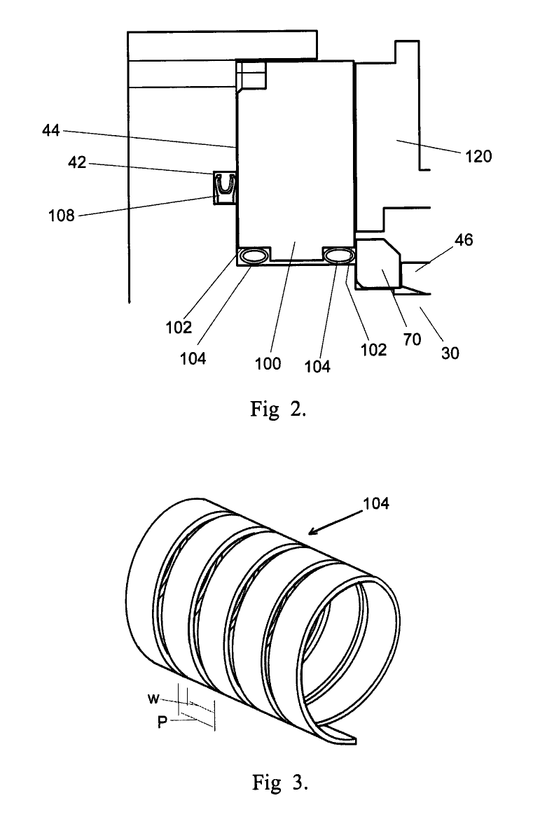

As illustrated in greater detail in FIG. 2, the inboard seal 10 has a mating seal ring 100 which is located in the recess 40 formed in the flange formation 38 of inner sleeve member 30, with clearances between the inner circumferential surface of the mating ring 100 and the inner circumferential wall of the recess 40; and between the outer circumferential surface of the mating ring 100 and the outer circumferential wall of the recess 40.

Similarly, the outboard seal 12 has a mating ring 100′ which is located in the increased diameter portion of the bore of the flanged portion 58 of the radially outer sleeve member 46, with clearances between the inner circumferential surface of the mating ring 100′ and the outer circumferential surface of the axially outer sleeve member 66; and between the outer circumferential surface of the mating ring 100′ and the circumferential surface of the enlarged bore.

Each of the mating rings 100, 100′ has a pair of annular recesses 102 in its inner circumferential surface, the recesses 102 extending from each radial face of the mating ring 100. 100′. Helical spring elements 104 are located in the recesses 102, the helical spring elements extending annularly around the grooves 102.

The helical spring elements 104 in recesses 102 of mating ring 100 of the inboard seal 10 are compressed radially between the mating ring 100 and the inner circumferential wall of recess 40, thereby centering the mating ring 100, with respect to the inner sleeve member 30. The helical spring element 104 in the outboard groove 102 of mating ring 100 is furthermore compressed axially between the radial wall of recess 102 and the opposed radial face of ring 70, to bias the mating ring 100 into engagement with a polymer seal 108 located in groove 42 in the radial base 44 of the recess 40 in order to seal the mating ring 100 to the inner sleeve member 30.

Similarly the helical spring elements 104 of the outboard seal 12 are compressed radially between mating ring 100′ and the outer circumferential surface of the axially outer sleeve member 66, to centre the mating ring 100′. Also the outboard helical spring element 104 is compressed axially between the radial shoulder 62 and the opposed radial surface of flange formation 72 on the axially outer sleeve member 66, to bias the mating ring 100′ into sealing engagement with a polymer seal 110 located in the groove 64 in radial shoulder 62.

In addition to centering the mating rings 100. 100′, the helical spring elements 104 and the clearances on the internal and external surfaces of the mating rings 100, 100′ permit thermal expansion and contraction of the mating rings 100, 100′ relative to the sleeve members 30, 66. Moreover, the helical spring elements 104 will transmit drive between the sleeve members 30, 66 and the mating rings 100. 100′. There is consequently no need for drive pins, although a pin 112 is provided which is located in a bore in the sleeve member 30, 46 and engages a bore in the mating ring 100. 100′. This pin is however for positioning purposes only and does not serve to transmit drive.

Each of the inboard and outboard seals 10, 12 have a primary ring 120 which is located coaxially of the mating ring 100, 100′ by the outer housing assembly 20. An outer flange formation 122 on the primary ring 120 has a plurality of angularly spaced lugs 124, which engage corresponding axially extending grooves 126 on the housing assembly, to locate the primary rings 120 rotationally with respect to the housing assembly 20, whilst permitting axial movement of the primary ring 120.

The primary ring 120 is urged into sealing engagement with the mating ring 100, 100′, by means of a thrust ring 130. The thrust ring 130 is slidably mounted in a reduced diameter portion 132 of the housing assembly 20 and is sealed with respect thereto by sealing element 134. A series of angularly spaced helical compression springs 136 act axially between the thrust ring 130 and the reduced diameter portion 132 of the housing assembly 20 to urge the thrust ring 130 axially towards the mating ring 100, 100′ and the primary ring 120 into sealing engagement with the mating ring 100, 100′. The primary ring 120 is sealed with respect to the thrust ring 130 by means of a polymer seal 138 which is located in an annular groove 140 in the thrust ring 130.

In order to facilitate assembly, the housing assembly 20 is formed in two sections 20′, 20″ which are secured together by means of a plurality of angularly spaced bolts 150. In order to maintain the integrity of the cartridge assembly keeper plates 152 are provided at the ends of grooves 126 to prevent the primary rings 120 from being forced out of the grooves 126 by the springs 136. A labyrinth seal 154 is also clamped between the two parts 20′, 20″ of the housing assembly 20, to provide a seal against the outer circumferential surface of the flange formation 58.

The housing assembly is secured to the machine housing 22 in conventional manner, for example by means of a plurality of angularly spaced axially extending bolts which engage through a flange formation provided at the outboard end of the housing assembly 20. Sealing elements 160 located in grooves 162 in the outer circumferential surface of the housing assembly 20 provide a seal between the various sections of the housing assembly 20 and the machine housing 22.

As illustrated in FIG. 3 the helical spring elements 104 are formed from wire of rectangular section, the width (W) of the wire being disposed axially of the spring element while the thickness is disposed radially. The actual dimensions of the wire and the helical spring will depend on the dimensions of the seal, the spring rate required and the operating conditions, for example operational temperature, of the seal. However preferably the width to thickness ratio of the wire will be from 5:1 to 10:1 and the pitch (P) to width (W) ratio will be between 1:1 and 2:1. In a typical example, the helical spring element is formed from a wire of rectangular section having a width of 0.58 mm and thickness of 0.08 mm, such that the diameter of the helical spring element 104 is 2.46 mm and the pitch of the convolutions of 0.93 mm.

Referring to FIG. 3, one advantage of using helical spring elements 104 is to have an increase in surface area in comparison to a conventional annular ring, such as a solid elastomeric o-ring. The increase in surface area allows the helical spring elements 104 to absorb heat efficiently and expand. Therefore, the helical spring elements 104 will expand together with the thermal expansion of the sleeve 18, 66 and compensate the thermal growth differentials between the sleeve 18, 66 and its respective mating ring 100, 100′.

In addition, the annular ring 70 and flange 72 axially compress the helical spring elements 104 to restrict axial movement of the mating rings 100, 100′, thereby preventing the mating rings 100, 100′ from axial free-floating. Furthermore, the annular ring 70 and flange 72 also prevent the helical spring elements 104 from being extruded out of the recesses 102 during thermal expansion.

According to a further embodiment of the invention, the helical spring elements 104 may be located between an external circumferential surface of the mating ring 100, 100′ and an opposed circumferential surface of the associated component.

Various modifications may be made without departing from the invention, for example while in the above embodiment the helical spring element 104 is formed from wire of rectangular section, wire of any elongate section may be used.

This invention may be used with contact seals where the sealing surfaces of both the mating and the primary rings will be planar, or with hydrodynamic gas seals, where grooved areas are provided on either a sealing face of the primary ring or the mating ring.

Moreover while the invention has been described with reference to a double seal, it may also be applied to a single seal or multiple seals of other configuration.

1.-12. (canceled)

13. A seal (10, 12) comprising:
a mating ring (100, 100′) mounted in fixed axial and rotational relationship with respect to a first component (14) of a pair of relatively rotatable first and second components (14, 16); and
a primary ring (120, 120′) mounted in a fixed rotational relationship but movable axially with respect to the second component (16);
means (136) being provided for urging the primary ring (120, 120′) axially into sealing engagement with the mating ring (100, 100′), and the mating ring (100, 100′) being mounted with respect to the first component (14) in abutment with a first radial face (44, 62) on the first component (14),
wherein a circumferential surface of the mating ring (100, 100′) is spaced radially from a circumferential surface on the first component (14) and an annular helical spring element (104) is located, under radial compression, between the circumferential surfaces, the annular helical spring element (104) is formed from wire of elongate section, and an axial width of the section being greater than the radial thickness.

14. The seal (10, 12) according to claim 13, wherein the helical spring element (104) is formed from wire of rectangular section.

15. The seal (10, 12) according to claim 14, wherein a ratio of the axial width to a radial thickness of the wire is from 5:1 to 10:1.

16. The seal (10, 12) according to claim 13, wherein a ratio of a pitch of the convolutions of the helical spring element (104) to the axial width of the wire is between 1:1 and 2:1.

17. The seal (10, 12) according to claim 16, wherein the ratio of the pitch of the convolutions of the helical spring element (104) to the axial width of the wire is of the order of 1.6:1.

18. The seal (10, 12) according to claim 13, wherein the helical spring element (104) is compressed axially between a radial face of the mating ring (100, 100′) and a second radial face provided on the first component (14), for urging the mating ring (100, 100′) axially into sealing engagement with the first radial face (44, 62).

19. The seal (10, 12) according to claim 18, wherein a secondary sealing element (108, 110) is located between the mating ring (100, 100′) and the first radial face (44, 62) to provide a seal therebetween.

20. The seal (10, 12) according to claim 19, wherein a polymer seal (108, 110) is located between the mating ring (100, 100′) and the first radial face (44, 62).

21. The seal (10, 12) according to claim 13, in which a pair of helical spring elements (104) are located in axially spaced annular recesses (102) in the inner circumferential surface of the mating ring (100, 100′), and the helical spring elements (104) are compressed between the circumferential base of each of the recesses (102) and an opposed circumferential surface on the first component (14).

22. The seal (10, 12) according to claim 13, in which the circumferential surface on the first component (14) is formed by a sleeve member (30, 62) secured both axially and rotatably and sealed with respect to the first component (14).

23. A centering element for centering a first component (100, 100′) of a pair of coaxial components (100. 100′; 30, 66) with respect to the second component (30, 66) comprising an annular helical spring element (104),
wherein the annular helical spring element (104) is formed from wire of elongate section, and an axial width of the section is greater than a radial thickness thereof.

24. A seal (10, 12) substantially as described herein, with reference to and as shown in FIGS. 1 to 3 of the accompanying drawings.
